(19) United States
(12) Patent Application Publication
(10) Pub. No.: US 2017/0372387 A1
(43) Pub. Date: Dec. 28, 2017

(54) Methods, Systems, and Devices for Pushing and Displaying Information

(71) Applicant: Beijing Xiaomi Mobile Software Co., Ltd., Beijing (CN)

(72) Inventors: Yu CHENG, Beijing (CN); Xu ZHANG, Beijing (CN); Jing LIU, Beijing (CN)

(73) Assignee: Beijing Xiaomi Mobile Software Co., Ltd., Beijing (CN)

(21) Appl. No.: 15/627,908

(22) Filed: Jun. 20, 2017

(30) Foreign Application Priority Data
Jun. 22, 2016 (CN) PCT/CN2016/086686

(51) Int. Cl. G06Q 30/06; G06F 17/30; G06Q 20/22; H04W 64/00; G06Q 20/24; G06Q 20/26

(52) U.S. Cl. CPC G06Q 30/06; G06Q 20/227; H04W 64/003; G06F 17/30103; G06Q 20/26; G06Q 20/24

(57) ABSTRACT

The present disclosure provides methods and devices for displaying information, methods, devices and systems for pushing information, relating to the field of network technology. The method includes: sending, by a terminal, bank card information of a bound bank card to a server; sending, by the terminal, a geographical location to the server; receiving, by the terminal, commercial service information pushed by the server, in which the commercial service information matches the bank card information and the geographical location; and displaying, by the terminal, the commercial service information.

### CROSS REFERENCE TO RELATED APPLICATION

This application is based upon and claims a priority to International Application No. PCT/CN2016/086686, filed with the State Intellectual Property Office of P. R. China on Jun. 22, 2016, the entire contents of which are incorporated herein by reference.

### TECHNICAL FIELD

The present disclosure generally relates to the field of computer networking, and more particularly to, a method and a device for displaying information, and a method, a device and a system for pushing information.

### BACKGROUND

A bank card (such as a debit card issued by a bank) is a commonly used payment tool in daily life. The bank card may combine a deposit card (linked to a bank account) and a credit card (linked to a credit account).

For certain bank cards of a bank, a vendor cooperating with the bank may provide special (promotional) offers (such as discounts). For example, for a credit card issued by bank A, the vendor may provide a discount (such as 40% off) during specified time periods (such as every Wednesday between 6:00 pm and 10:00 pm). In the related art, the vendor posts discount information to a user via an official website or an official blog. However, the user remains unaware of new discount information that may interest the user unless he or she actively visits the official website or the official blog of the vendor on a regular basis.

### SUMMARY

The present disclosure provides a method and a device for displaying information, a method, a device and a system for pushing information. Technical solutions include the following.

According to a first aspect of the present disclosure, a method for displaying information is provided. The method may be implemented at least partially by a user terminal. The user terminal transmits bank card information of a bank card to a server, the bank card being linked with one or more accounts of the bank card holder. The user terminal determines a geographical location of the user terminal, and transmits the geographical location from the user terminal to the server, where the geographical location of the user terminal is associated with where the bank card holder is located. The user terminal receives commercial service information pushed by the server, where the commercial service information includes a promotional offering available at a redemption point, where the promotional offering is provided by a vendor during a period of time. The commercial service information is pushed to the user terminal when both: the geographical location of the user terminal is no farther than a preset distance from the redemption point, and the promotional offering is redeemable by the bank card holder. The user terminal displays the commercial service information at the user terminal to inform the bank card holder of the promotional offering available at the nearby redemption point.

According to a second aspect of the present disclosure, a method for pushing information is provided. The method includes: acquiring bank card information linked with a bank card holder having a user terminal; acquiring a geographical location of the user terminal from the user terminal; querying commercial service information for applicability to the bank card holder, wherein the commercial service information includes a promotional offering available at a redemption point. The commercial service information is applicable to the bank card holder when both following conditions are met: the geographical location of the user terminal is no farther than a preset distance from the redemption point; and the promotional offering is redeemable by the bank card holder. The method may further include pushing the commercial service information to the user terminal to inform the bank card holder of the promotional offering available for redemption by the bank card holder at the nearby redemption point.

According to a third aspect of the present disclosure, a device for displaying information is provided. The device includes: a processor and a memory configured to store an instruction executable by the processor. The processor is configured to: transmit bank card information of a bank card to a server, the bank card being linked with one or more accounts of the bank card holder; determine a geographical location of the device and transmit the geographical location to the server, wherein the geographical location is associated with where the bank card holder is located; receive commercial service information pushed by the server, wherein the commercial service information includes a promotional offering available at a redemption point, the promotional offering being provided by a vendor during a period of time. The commercial service information is pushed to the device when both: the geographical location of the device is no farther than a preset distance from the redemption point, and the promotional offering is redeemable by the bank card holder. The processor may father be configured to display the commercial service information to inform the bank card holder of the promotional offering available at the nearby redemption point.

According to a fourth aspect of the present disclosure, a device for pushing information is provided, which includes: a processor and a memory configured to store an instruction executable by the processor. The processor is configured to: acquire bank card information bound to a terminal; acquire a geographical location of the terminal; query commercial service information matching the bank card information and the geographical location; and push the commercial service information to the terminal.

According to a fifth aspect of the present disclosure, a system for pushing information is provided, which includes: a terminal and a server for pushing information. The terminal includes the device for displaying information according to the third aspect; and the server for pushing information includes the device for pushing information according to the fourth aspect. The terminal includes the device for displaying information according to the fifth aspect; and the server for pushing information includes the device for pushing information according to the sixth aspect.

It is to be understood that both the foregoing general description and the following detailed description are exemplary and explanatory only and are not restrictive of the present disclosure.

### BRIEF DESCRIPTION OF THE DRAWINGS

Accompanying drawings herein are incorporated in and constitute a part of the specification, and illustrate example embodiments in line with the present disclosure, and serve to explain the principle of the present disclosure together with the description.

FIG. 1 is a schematic diagram illustrating an example system for pushing information according to one or more example embodiments of the present disclosure;

FIG. 2 is a flow chart illustrating an example method for pushing information according to one or more example embodiments of the present disclosure;

FIG. 3 is a flow chart illustrating an example method for pushing information according to one or more example embodiments of the present disclosure;

FIG. 4A illustrates a flow chart illustrating an example method for displaying commercial service information on a terminal according to one or more example embodiments of the present disclosure;

FIG. 4B is a schematic diagram illustrating an example user interface for displaying commercial service information on a terminal according to one or more example embodiments of the present disclosure;

FIG. 5A illustrates a flow chart illustrating an example method for displaying commercial service information on a terminal according to one or more example embodiments of the present disclosure;

FIG. 5B provides a schematic diagram illustrating interfaces when commercial service information is displayed on a terminal according to one or more example embodiments of the present disclosure;

FIG. 5C provides a schematic diagram illustrating interfaces when commercial service information is displayed on a terminal according to one or more example embodiments of the present disclosure;

FIG. 5D provides a schematic diagram illustrating interfaces when commercial service information is displayed on a terminal according to one or more example embodiments of the present disclosure;

FIG. 5E provides a schematic diagram illustrating interfaces when commercial service information is displayed on a terminal according to one or more example embodiments of the present disclosure;

FIG. 5F provides a schematic diagram illustrating interfaces when commercial service information is displayed on a terminal according to one or more example embodiments of the present disclosure;

FIG. 6 is a flow chart illustrating an example method for pushing information according to one or more example embodiments of the present disclosure;

FIG. 7 is a block diagram illustrating an example device for displaying information according to one or more example embodiments of the present disclosure;

FIG. 8 is a block diagram illustrating an example device for pushing information according to one or more example embodiments of the present disclosure;

FIG. 9 is a block diagram illustrating an example terminal according to one or more example embodiments of the present disclosure; and

FIG. 10 is a block diagram illustrating an example server according to one or more example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of example embodiments of the present disclosure.

### DETAILED DESCRIPTION

Reference will now be made in detail to example embodiments, potential implementations of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of devices and methods consistent with aspects related to the invention as recited in the appended claims.

FIG. 1 is a schematic diagram illustrating an example system for pushing information according to an example embodiment of the present disclosure. The system may include one or more commercial promoting terminals 120, a server 140, and one or more terminals 160.

The commercial promoting terminal 120 is a terminal used by (or on behalf of) one or more merchants. The commercial promoting terminal 120 may be, in various configurations, embodied by, for example, one or more computing devices, such as smart phones, tablet computers, portable computers, desktop computers, etc. (or combinations thereof). Alternatively, the promoting terminal 120 is any source of commercial service information, such as a promoting client configured to upload commercial service information to the server 140. In certain configurations, the promoting client may be a promoting application or a webpage client.

In one or more implementations, the commercial promoting terminal 120 may be wired or wirelessly connected to the server 140 via a communications network that uses, for example, Internet or other communications protocols.

The server 140 may be one server, a plurality of servers or a cloud computing center. Alternatively, the server 140 may be a background server of a payment application, in which the payment application may be a single functional application only configured with a payment function, or may be an integrated application combining with the payment function. The payment application may be provided by a bank, a vendor, etc. The server 140 is configured to manage the commercial service information uploaded by the commercial promoting terminal 120, and to push the commercial service information to the terminal 160 selectively.

Alternatively, the server 140 is also connected to the terminal 160 via a communications network.

The terminal 160 is a terminal used by an end user. The terminal 160 may be, for example, a smart phone, a tablet computer, a portable computer, a desktop computer, or other computing device. In certain configurations, a payment application is installed on the terminal 160. In one or more embodiments, a locating module (for determining the physical location of the terminal 160) is included in the terminal 160, in which the locating module may include at least one of hardware integrated circuits such as: an iBeacon locating module, a GPS (Global Positioning System) locating module, a WIFI (Wireless Fidelity) locating module, and a base station locating module. The terminal 160 is configured with a function for using the locating module for determining a geographical location thereof (i.e., for locating the terminal 160).

The terminal 160 is configured to receive the commercial service information sent by the server 140, and to display the commercial service information to the user.

In one or more implementations, the commercial service information may include, but is not limited to, at least one of discount information, group-purchasing information, advertising information, new product introducing information, and special offer information of a vendor.

In one or more implementations, the network may use standard communication technology and/or protocols. The network may be the Internet, or other networks including, but not limited to, Local Area Network (LAN), Metropolitan Area Network (MAN), Wide Area Network (WAN), mobile network, wired network, wireless network, private network or virtual private network, or any combination thereof deemed suitable for different applications. Technology or formatting, such as Hypertext Markup Language (HTML), Extensive Markup Language (XML), etc., may be used to represent data exchanged via the network. In addition, a common encryption technology, such as Security Socket Layer (SSL), Transport Layer Security (TLS), Virtual Private Network (VPN) Internet Protocol Security (IPsec), etc., may be used to encrypt all or some links. In other embodiments, an entity may also use a custom and/or private data communication technology to replace or supplement the data communication technology described above. The network may include a link to other networks (such as the Internet), according to embodiments of the present disclosure.

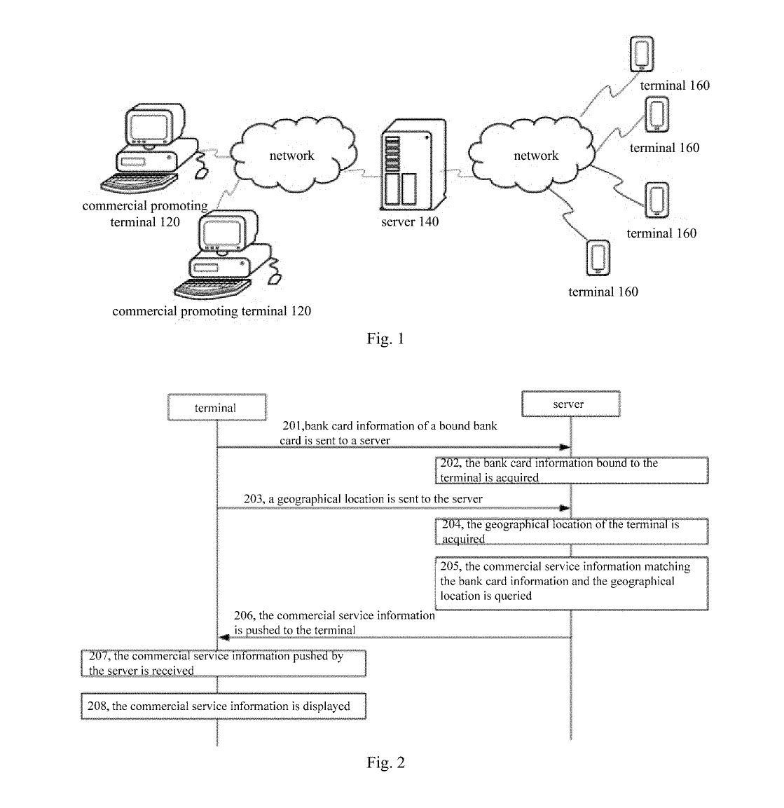

FIG. 2 is a flow chart illustrating an example method for pushing information according to one or more embodiments of the present disclosure. The method may be implemented using the server 140 and the terminal 160 illustrated in FIG. 1. The depicted method may include the following acts.

In act 201, a terminal sends bank card information of a bound (i.e., linked or associated) bank card to a server. The bank card may be bound to one or more accounts of a card holder (i.e., the one or more persons or entities to which the bank card is issued). The accounts may include a debit account (linked to, e.g., a checking or savings account) and/or a credit account (associated with, e.g., a credit card). The bank card may be usable as a debit card (e.g., to withdraw money), and/or as a credit card (e.g., to charge purchases or withdrawals against one or more credit accounts).

In one or more implementations, the bound bank card may combine a deposit card and a credit card. The deposit card is a “saving money before withdrawing” card supporting basic service including saving, withdrawing, transferring and remitting etc.; the credit card is a “buy now, pay later” payment tool supporting microcredit or a card supporting purchasing and consuming at a certain vendor or saving and withdrawing cash at a specific bank.

In one or more implementations, the bank card information may include at least one of: a bank name, a card type, account information (e.g., account number), level information (e.g., withdrawal and/or credit limits), and holder information (e.g., name of the card holder) corresponding to the bank card. As the commercial service information corresponds to the card type generally (i.e., is related to promotions redeemable to holders of the card type), in some embodiments, the bank card information may include at least the card type. The card type is classified by the bank, and a same bank may release different bank cards with different types. For example, the card type may include: a student card, a transportation card, a fuel-filling cooperation card, a food credit card, a shopping credit card, etc.

In one or more implementations, the user terminal sends the bank card information to the server at a preset time interval, or sends the bank card information to the server when the terminal is bound with a new bank card.

In act 202, the server acquires the bank card information bound to the terminal.

In act 203, the terminal sends a geographical location to the server.

In one or more configurations, the user terminal may acquire the geographical location thereof via a locating technology and send the geographical location to the server.

In act 204, the server acquires the geographical location of the user terminal.

In act 205, the server queries the commercial service information matching (i.e., corresponding to or relevant to) the bank card information and the geographical location. The server may determine, for example, whether there is commercial service information that is relevant to the bank card holder associated with the user terminal based on the geographical location of the user terminal, on whether a promotion is still available (or will soon be available), and on whether the promotion is available to holders of the bank card. The server may search for, or otherwise access, commercial service information (which may be stored in a database) identifying a redemption point for a promotion (e.g., a physical location for where a promotion may be redeemed/received, such as a merchant and/or an address for a merchant) that is in the vicinity of (e.g., within 2000 meters, 200 meters, 20 meters, etc.) the user terminal, is redeemable by (i.e., available to) the bank card holder associated with the user terminal, and is either available now or will be available within a specified duration (e.g., the same day, within the hour, etc.). The commercial service information queried may also include such promotion details as the products and/or services being discounted, percentage off, the requirements for eligibility for the promotion (e.g., a particular shopping status or membership in, e.g., a “rewards” program of the merchant or bank affiliate/vendor), acts that must be performed for redemption (such as displaying an image or message on the user terminal), etc.

In certain implementations, the card type supported by the commercial service information matches the bank card information in the terminal, and a distance between the geographical location of the terminal and a location of a vendor/merchant is less than a preset threshold, the location of the vendor is the geographical location of the vendor corresponding to the commercial service information.

In one or more configurations, a corresponding relationship between the bank card information, the location of the vendor, and the commercial service information is stored in the server. An example corresponding relationship is shown in Table. 1.

TABLE 1

| | Location of | Commercial Service |
|---|---|---|
| Bank Card Information | Vendor | Information |
| Gold card of XX bank | Location 1 | 40%-off discount every |
| | | Wednesday |
| Food credit card of | Location 2 | [symbol] 20 coupon for any |
| YY bank | | goods and services |
| Undergraduate credit | Location 3 | [symbol] 168 for double persons |
| card of ZZ bank | | in a group-purchasing activity |
| Black diamond deposit | Location 4 | Free dinner on Monday |
| card of MM Bank | | |
| . . . | . . . | . . . |

In act 206, the server pushes the commercial service information to the user terminal.

In act 207, the user terminal receives the commercial service information pushed by the server.

In act 208, the user terminal displays the commercial service information to inform the user of a potential opportunity that is available to specific bank card holders and may be immediately redeemable without excessive travel or wait.

Consequently, with the example method for pushing information according to embodiments of the present disclosure, by acquiring the bank card information and the geographical location of the terminal by the server, querying the commercial service information matching the bank card information and the geographical location, and pushing the commercial service information to the terminal, a problem in the related art that a user is able to acquire the commercial service information only when the user visits an official website or an official blog of the vendor actively may be solved, and an effect that the server may push the commercial service information to the terminal actively and the user may acquire the commercial service information without querying may be realized.

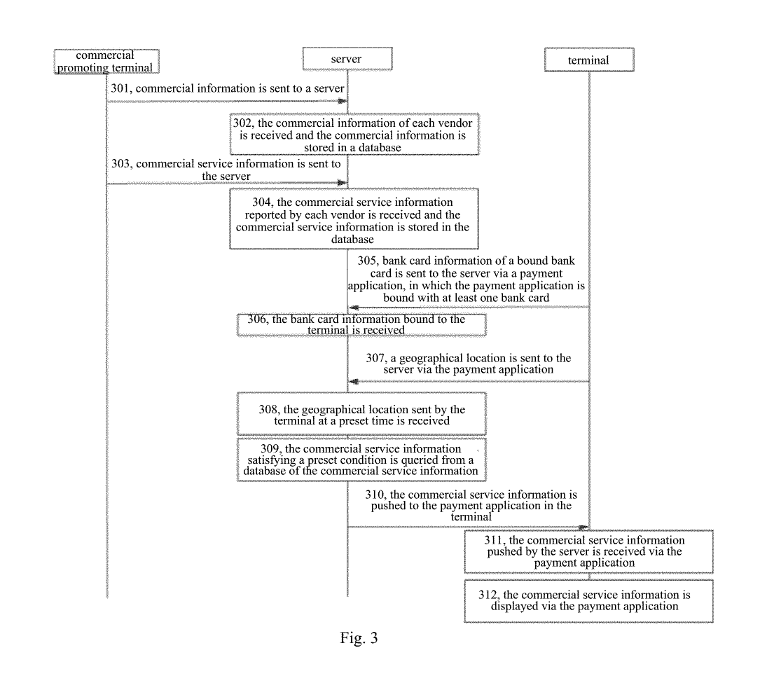

FIG. 3 is a flow chart illustrating an example method for pushing information according to one or more embodiments of the present disclosure. This embodiment of the present disclosure may be implemented using the system for pushing information illustrated in FIG. 1. The depicted method may include following acts.

In act 301, a commercial promoting terminal reports commercial information to a server.

A vendor may register a commercial account in the server via the commercial promoting terminal. In a process of registering, each vendor reports the commercial information to the server. Completing a registration process would allow the vendor to offer promotions.

In one or more implementations, the commercial information may include one or more of: an account type (e.g., corresponding with the types of promotions or the types of bank cards through which promotions will be available), a name (e.g., a business name, d/b/a/name, merchant name, etc.), a geographical location (e.g., a location of a merchant), a service content (e.g., types of promotions, discounts, goods, services, etc.), and a user rating of the vendor (e.g., reviews by users, reported experiences of users, user satisfaction awards), etc.

In act 302, the server receives the commercial information of each vendor and stores the commercial information in a database.

In act 303, the commercial promoting terminal reports commercial service information to the server. This may occur, for example, as part of the registration process, or separately from registration at a later time, as promotions are to be made available.

In one or more implementations, the vendor has a cooperation relationship with one or more banks (i.e., is affiliated with, has a business relationship with, etc.). At different times, the vendor may launch special offers for a bank card of a certain type issued by a certain bank. When special offers (i.e., promotions) are to be launched, the commercial promoting terminal reports the commercial information to the server.

In one or more implementations, commercial service information has attributes including one or more supported card types, identification of a location corresponding to the vendor or a redemption location (e.g., a merchant at which a special offer is available), and an expiry date (e.g., a time span during which a promotion is available for redemption).

In act 304, the server receives the commercial service information reported by each vendor and stores the commercial service information in the database.

In act 305, the terminal sends bank card information of a bound bank card to the server via a payment application, in which the payment application is bound (i.e., linked or otherwise usable) with at least one bank card.

In one or more embodiments, the payment application may be a single functional application only configured with a payment function, or may be an integrated application providing a payment function.

In one or more embodiments, the bank card information may include at least one of: a name of a bank issuing the bank card, a card type, account information, level information, and holder information corresponding to the bank card. As the commercial service information corresponds to the card type generally, in some embodiments, the bank card information may include at least the card type. The card type is classified by the bank, and the same bank may release different bank cards of different types. Example card types include: a student card, a transportation card, a fuel-filling cooperation card, a food credit card, and a shopping credit card etc.

In one or more embodiments, the payment application in the terminal sends the bank card information to the server at a preset time interval, or sends the bank card information to the server when the terminal is starting, or sends the bank card information to the server when the terminal is bound with a new bank card.

In act 306, the server receives the bank card information bound to (i.e., linked or associated with) the terminal.

In act 307, the terminal sends a geographical location of the user terminal to the server via the payment application.

In one or more embodiments, the terminal may acquire the geographical location thereof via a locating technology and send the geographical location to the server.

In order to ensure that the geographical location sent by the terminal to the server is a relatively real-time geographical location, the terminal may send the geographical location to the server when booting; or the terminal may send the geographical location to the server when the payment application is starting; or the terminal may send the geographical location to the server at a predetermined time interval. Determination and/or verification of a current or recent geographical location may be accomplished using any location technology available to the user terminal.

In act 308, the server receives the geographical location sent by the terminal at a preset time.

The preset time may include at least one of: a time when the terminal is booting; a starting time of the payment application in the terminal; a predetermined time or time interval (such as a periodic “update” time); upon a trigger event (such as a change in location, vicinity to a shopping center, response to a user inquiry, etc.).

In one or more embodiments, act 307 and act 305 are independent in terms of execution time and the number of executions. For example, act 305 may be executed only when the new card is bound, while act 307 may be executed several times at the predetermined time interval.

In act 309, the server queries the commercial service information satisfying a preset condition from a database of the commercial service information.

In one or more embodiments, the preset condition includes one or more of: the supported card type matching the bank card information, and, a distance between the location of the vendor and the geographical location being less than a preset threshold. The location of the vendor, which is the geographical location of the vendor corresponding to the commercial service information, may be a place of business that serves as a redemption point for a special offer.

In act 310, the server pushes the commercial service information to the payment application in the terminal.

In one or more embodiments, the payment application in the terminal may send a long HTTP connection request in advance and wait for a response from the server thereafter. The server may establish a connection with the payment application in the terminal after receiving the long HTTP connection request. Instead of sending the commercial service information immediately, the server may suspend the connection. The server may send the commercial service information to the payment application in the terminal via the connection actively, if the commercial service information exists in the server. After the commercial service information is received, the payment application in the terminal may process the commercial service information and send a next long HTTP connection request to the server.

In one or more embodiments, the pushing of the commercial service information may be realized by using other pushing techniques between the server and the terminal.

In act 311, the terminal receives the commercial service information pushed by the server via the payment application.

In act 312, the terminal displays the commercial service information via the payment application.

In one or more embodiments, the terminal displays the commercial service information via a GUI (Graphical User Interface) of a card in the payment application. The terminal may display the commercial service information in a displaying format including at least one of a logo, a list, a combination of pictures and text, and an animation. Other audiovisual indicators may be used as well, such as sounds emitted to alert a user of commercial service information. Different sounds may be associated with different bank cards, vendors, locations, types of special offers, etc.

The displaying format of the commercial service information is not limited in embodiments of the present disclosure.

Consequently, according to the example method for pushing information in embodiments of the present disclosure, by acquiring the bank card information and the geographical location of the terminal by the server, querying the commercial service information corresponding to the bank card information and the geographical location, and pushing the commercial service information to the terminal, a problem in the related art that a user is able to acquire the commercial service information only when the user visits an official website or an official blog of the vendor actively may be solved, and an effect that the server may push the commercial service information to the terminal actively and the user may acquire the commercial service information without querying may be realized.

According to the method for pushing information provided by embodiments of the present disclosure, by querying the commercial service information matching the bank card information and the geographical location, the commercial service information pushed to the user may be strongly practical, highly effective and accurate information, which provides a better referable value for the user.

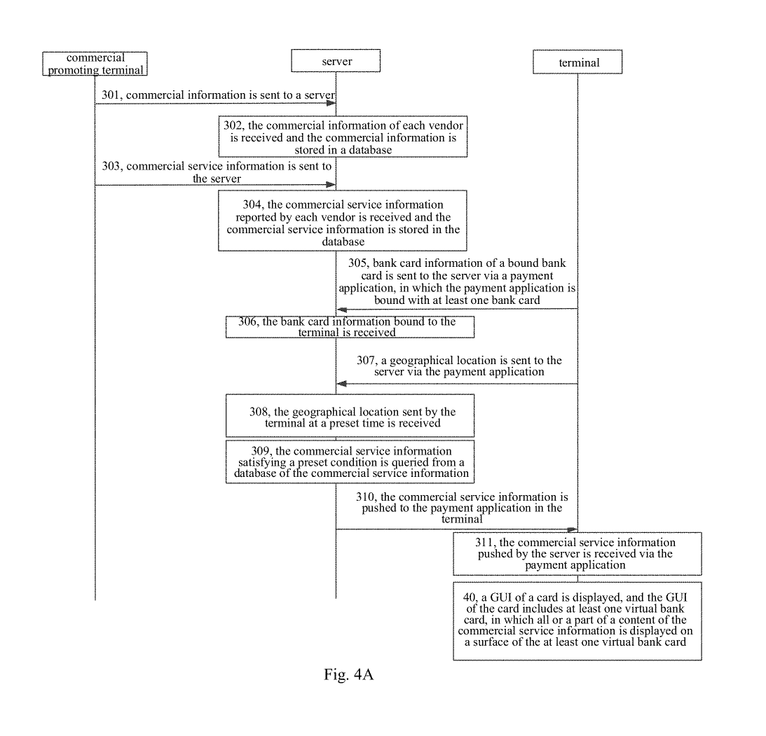

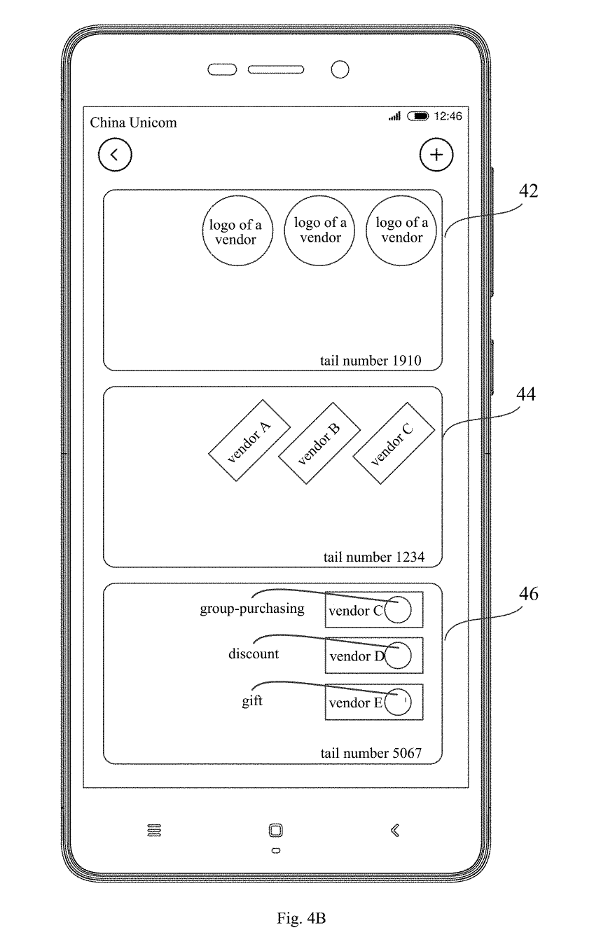

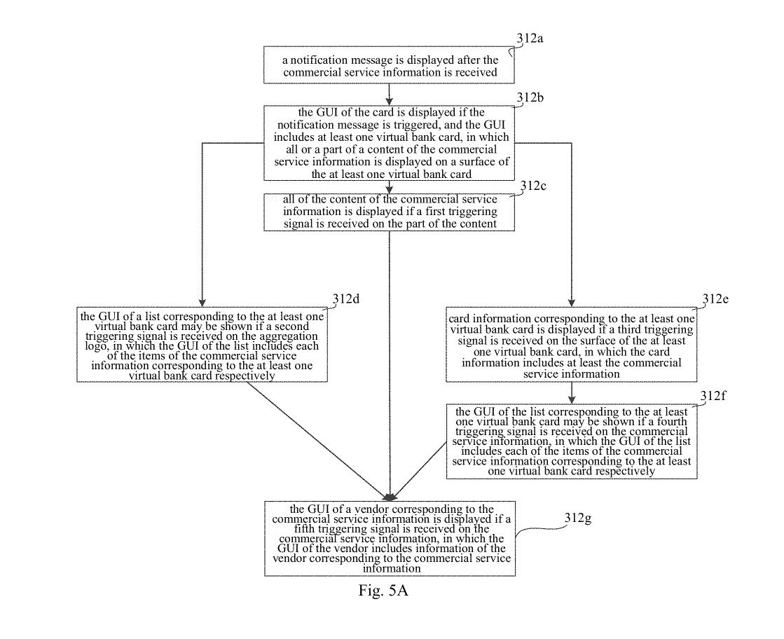

In one or more alternative embodiments, act 312 may be alternatively realized as act 40, as shown in FIG. 4A.

In act 40, the terminal displays a GUI of a card, and the GUI of the card includes at least one virtual bank card, in which all or a part of a content of the commercial service information is displayed on a surface of the at least one virtual bank card.

In one or more embodiments, each virtual bank card corresponds to a bound bank card. In one or more embodiments, the surface of the virtual bank card is the same as or similar to that of a physical bank card.

In one or more embodiments, the content of the commercial service information may include at least one of: a logo, a name, a user rating, an address, contact information, discount information, coupon information, group-purchasing information (e.g., offers for purchases by multiple consumers), gift information of a vendor (e.g., whether gift wrapping is available), and a distance between a current geographical location of the user terminal and the vendor/redemption point.

In one or more embodiments, the part of the content of the commercial service information is displayed on the surface of each virtual bank card, in which the part of the content is an item (e.g., discounted good or service) of the content or a combination of several items of the content.

Schematically, referring to FIG. 4B, at an upper-right corner of the surface of the virtual bank card 42, three logos are equally arranged in a row, in which each of the three logos may be pictures or a combination of pictures and text. At the surface of another virtual bank card 44, three names are equally arranged at an angle of 45 degrees, in which the three names may be text. At the surface of yet another virtual bank card 46, the names of vendors in the commercial service information and keywords “group-purchasing”, “discount”, and “gift” are equally arranged in a column, in which “group-purchasing” indicates that the commercial service information is the group-purchasing information, “discount” indicates that the commercial service information is the discount information, and “gift” indicates that the commercial service information is the gift information. Similarly, there may also be a keyword “favorable”, indicating that the commercial service information is the favorable price information.

Consequently, according to the example method for pushing information in embodiments of the present disclosure, by displaying all or the part of the content of the commercial service information on the virtual bank card, display space (i.e., space on the display screen) may be used effectively, and an effect of displaying is clean and straightforward (and thus user-friendly). The user may know where the commercial service information comes from by visualizing the logo, and may know the type of the commercial service information by visualizing the keywords, thus the commercial service information is strongly identifiable and easily readable information.

In an alternative embodiment, as shown in FIG. 4B schematically, the commercial service information displayed on the surface of the virtual bank card is the commercial service information corresponding to the bank card information of the virtual bank card, which means that the commercial service information displayed on the surface of the virtual bank card 42 corresponds to the bank card information of the virtual bank card 42; the commercial service information displayed on the surface of the virtual bank card 44 corresponds to the bank card information of the virtual bank card 44; and the commercial service information displayed on the surface of the virtual bank card 46 corresponds to the bank card information of the virtual bank card 46.

It should be noted that the displaying method mentioned above is a way for displaying the commercial service information matching each virtual bank card distinguishingly. Those skilled in the art may use other displaying methods such as using different GUIs each of which corresponds to one virtual bank card, or using different background colors each of which corresponds to one virtual bank card, or using different displaying shapes each of which corresponds to one virtual bank card, for displaying distinguishingly.

Consequently, according to the example method for pushing information in embodiments of the present disclosure, according to the arrangement of the commercial service information, the item of the bank card information corresponding to the commercial service information may be reflected, and thus an effect of saving displaying space is realized.

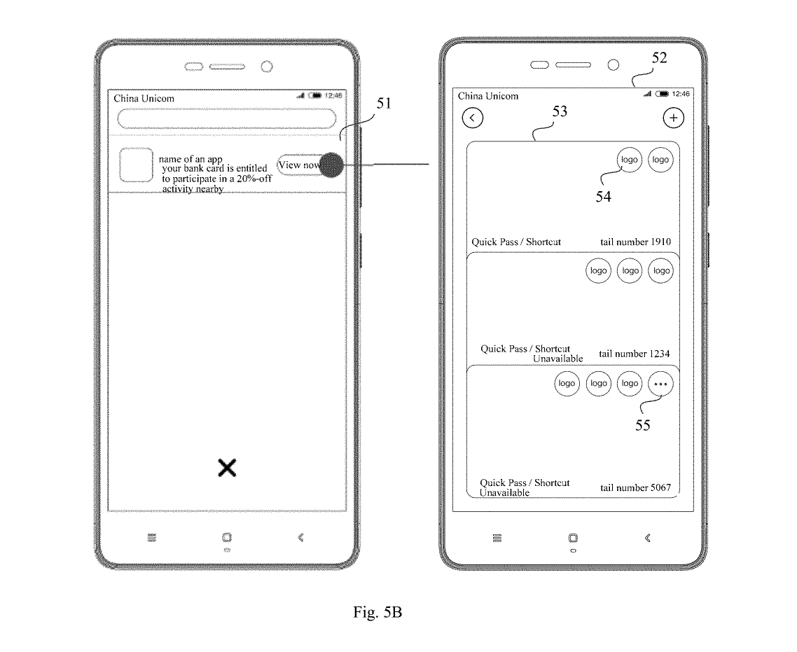

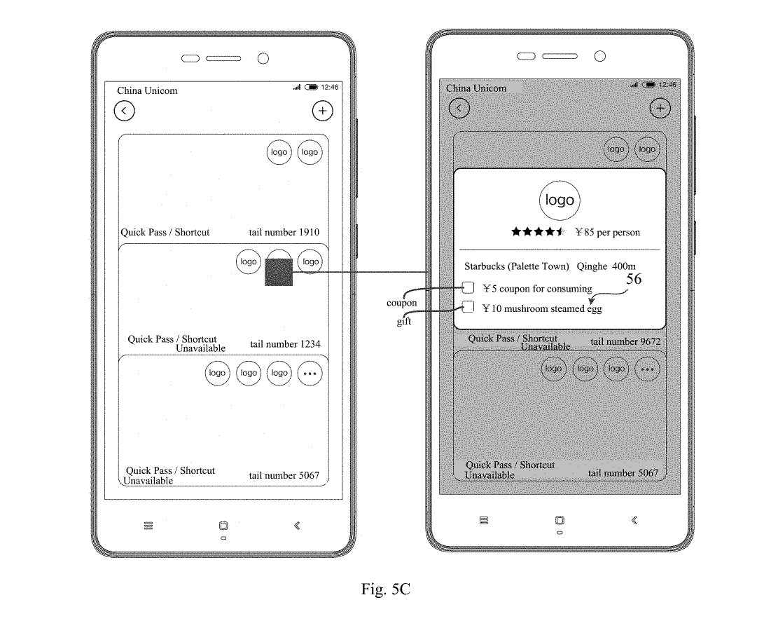

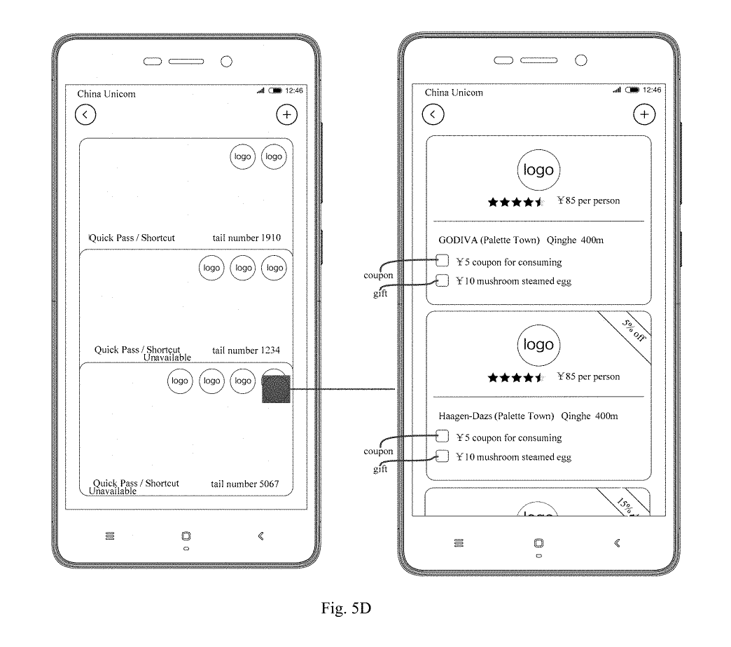

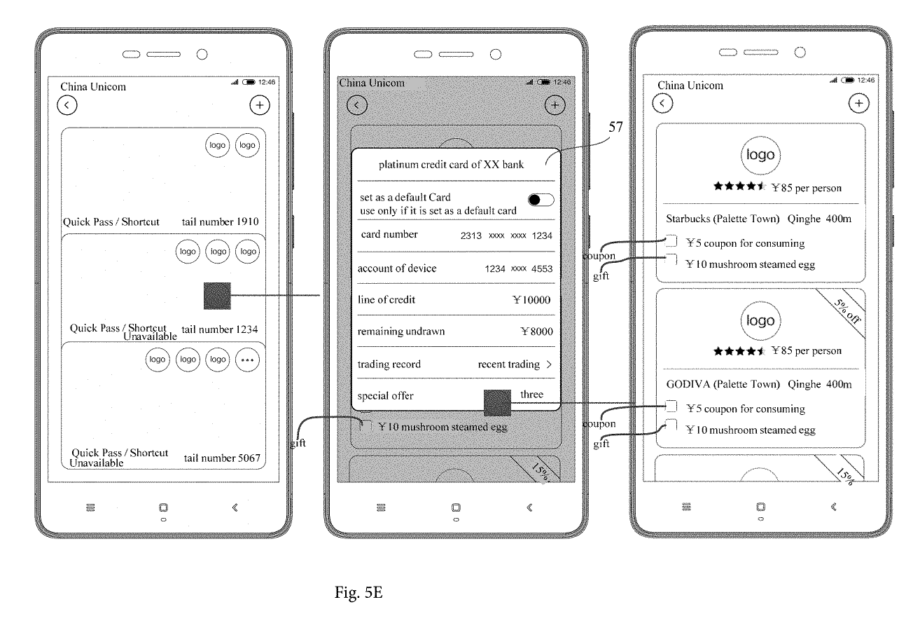

Embodiments of the present disclosure also provide a method for displaying commercial service information on a terminal. Referring to the example method of FIG. 5A, act 312 may be alternatively realized as acts 312a-312g.

In act 312a, a notification message is displayed after the commercial service information is received.

Schematically, as shown in the example implementation of FIG. 5B, the notification message is displayed in a message bar 51 after the commercial service information is received by the terminal. The notification message may include: a name of an application, a description of a promotional offer (represented by the text “your bank card is entitled to participate in a 20%-off activity nearby”), and a button “view now” to allow the user to receive more information.

In act 312b, the GUI of the card is displayed if the notification message is triggered (e.g., if “view now” is selected), and the GUI of the card includes at least one virtual bank card (e.g., bank cards 53, as discussed below), in which all or a part of a content of the commercial service information is displayed on a surface of the at least one virtual bank card.

The terminal displays the GUI 52 after a user clicks the button “view now”. Three virtual bank cards 53 are displayed on the GUI 52, in which the three virtual bank cards include a first bank card of which a tail (identifying, index, or reference) number is 1910, a second bank card of which the tail number is 1234, and a third bank card of which the tail number is 5067. Each of the three virtual bank cards 53 may correspond to a bound physical bank card issued to the bank card holder who uses the user terminal.

For example, when the part of the content of the commercial service information is displayed on the surface of the virtual bank card, in which the part of the content is a logo of a vendor, vendor logos 54 may be displayed on the surface of one of the virtual bank cards 53. FIG. 5B illustrates that the vendor logos 54 are displayed on the surfaces of the three virtual bank cards 53. Two of the vendor logos 54 are displayed on the surface of the first bank card (top), and three of the vendor logos 54 are displayed on the surface of the second bank card (middle).

In one or more implementations, when the number of the vendor logos 54 corresponding to one of the virtual bank cards 53 exceeds a preset number (which may correspond with, e.g., how much space is to be used on the representation of the virtual bank card or on display screen), as is the case with the third (bottom) virtual bank card 53, an aggregation logo 55 is displayed on a surface of the one of the virtual bank cards 53, in which the aggregation logo 55 is configured to indicate that the number of items of the commercial service information corresponding to one virtual bank card 53 exceeds the preset number. In one or more embodiments, the preset number is measured according to: the number of the items (goods or services) of the commercial service information; the number of the vendors corresponding to the commercial service information (e.g., the number of different merchants offering a special promotion); and/or the number of types of items (e.g., food, clothing, fuel, etc.) corresponding to the commercial service information.

For example, if the number of the vendor logos 54 corresponding to the third bank card exceeds three, the aggregation logo 55 may be displayed on the surface of the third bank card 53 (bottom).

In one or more embodiments, the commercial service information displayed on the surface of one of the virtual bank cards 53 is the commercial service information matching the bank card information of this virtual bank card 53. In FIG. 5B, the vendor logos 54 displayed on the surface of each of the virtual bank cards 53 correspond to (i.e., relate to the vendors offering the promotions specified in) the commercial service information matching the bank card information of the three virtual bank cards 53, respectively.

In one or more embodiments, the part of the content of the commercial service information displayed on the surface of a virtual bank card 53 (the vendor logos 54) may be configured as an entry control of (i.e., entry point for providing access to) all of the content of the commercial service information. Act 312c corresponds with this option.

In act 312c, all of the content of the commercial service information is displayed if a first triggering signal is received (i.e., a corresponding selection is made) on the part of the content.

Schematically, as shown in FIG. 5C, the terminal may display all of the content of the commercial service information 56 via a pop-up box if a second vendor logo on the second bank card is clicked (to provide the first triggering signal). All of the content of the commercial service information 56 may include: a logo of a product or vendor, a rating of a product or vendor, per capita consumption (i.e., cost per item, such as [symbol] 85), a name of the product or vendor, an address of a vendor, a distance between a current location of the user terminal and the vendor, coupon information, free food information, etc.

In one or more embodiments, the terminal may display all of the content of the commercial service information 56 by using a whole GUI. If all of the content of the commercial service information 56 is unable to be displayed completely (i.e., does not fit) in one GUI, a long GUI (i.e., portrait view) with a scroll bar may be used for a scrollable display, or several GUIs may be used for a page-by-page display (allowing additional content to be viewed by “page-turning”).

In act 312d, the list GUI corresponding to the at least one virtual bank card may be shown when a second triggering signal is received on (i.e., a selection is made via) the aggregation logo, in which the list GUI includes each of the items of the commercial service information corresponding to the at least one virtual bank card respectively.

Schematically, as shown in FIG. 5D, the terminal may jump to the list GUI corresponding to the third bank card when the aggregation logo on the third bank card is clicked (to provide the second triggering signal), in which the list GUI includes a plurality of items of the commercial service information corresponding to the third bank card. For example, FIG. 5D illustrates three example items of the commercial service information corresponding to the third bank card (bottom).

In act 312e, card information corresponding to the at least one virtual bank card is displayed when a third triggering signal is received on (i.e. a selection is made via) the surface of the at least one virtual bank card, in which the card information includes at least the commercial service information.

Schematically, as shown in FIG. 5E, the terminal may display the card information corresponding to the second bank card if the surface of the second bank card is clicked (to provide the third triggering signal), in which the card information includes: a name of a bank, a card type, whether it is a default card (e.g., a card selected by a bank card holder or other user as the card to be used for purchases unless an alternate selection is made), a number of the bank card, an account of a device (e.g., which account is associated with a user terminal), line of credit, remaining undrawn (i.e., available balance), a trading record (i.e., past charges, purchases, or withdrawals), and the commercial service information “special offer”.

In act 312f, the list GUI corresponding to the at least one virtual bank card may be shown when a fourth triggering signal is received on (i.e., a selection is made via) the commercial service information, in which the list GUI includes each of the items of the commercial service information corresponding to the at least one virtual bank card, respectively.

The terminal may jump to the list GUI corresponding to the second bank card (middle) when the “special offer” is clicked (to provide the fourth triggering signal), in which the list GUI includes three items of the commercial service information corresponding to the second bank card.

In act 312g, the GUI of a vendor corresponding to the commercial service information is displayed when a fifth triggering signal is received on (i.e., a selection is made via) the commercial service information, in which the GUI of the vendor includes information of the vendor corresponding to the commercial service information.

Schematically, as shown in FIG. 5F, the terminal may display the GUI of the vendor corresponding to the commercial service information if one item of the commercial service information is clicked (to provide the fifth triggering signal), in which the GUI of the vendor may include one or more of: a photo, a logo, a phone number, a WiFi password, an illustrated map, an address, a coupon, free food information, discount information, a payment entrance of the vendor, etc.

It should be noted that act 312a is an optional step, and the GUI of the card in act 312b may be triggered and displayed by using other methods. For example, the GUI may be triggered and displayed by using a card management menu of a payment application, or be triggered and displayed after paying via the payment application, or be triggered and displayed after a new bank card is bound, or be triggered and displayed while moving to a new location, and so on.

It should be noted that, act 312c may be an optional step. If all of the content of the commercial service information is displayed on the surface of the virtual credit card on the GUI of card in act 312b, the act 312c may be omitted.

It should also be noted that act 312d, act 312e, act 312f and act 312g mentioned above are independent of each other and are optional steps. Those skilled in the art may realize these four acts in other embodiments by choosing one of the four acts, or combining two or three of the four acts, which is not limited in embodiments of the present disclosure.

Consequently, according to the example method for pushing information of embodiments of the present disclosure, by displaying the commercial service information separately for each bank card, the commercial service information corresponding to each bank card may be clearly displayed to a user, and thus an effect of saving displaying space may be realized.

According to embodiments of the present disclosure, by displaying all of the content of the commercial service information after part of the content of the commercial service information is clicked (or otherwise selected), more commercial service information may be displayed on the GUI of the card, the user may view the commercial service information the user is interested in, so that the displaying space may be conserved and the amount of effective information displayable on the GUI of the card may be increased.

According to embodiments of the present disclosure, the list of the commercial service information may be displayed by triggering the aggregation logo, so that more content of a virtual bank card may be displayed on the GUI of the card if there is too much commercial service information corresponding to this virtual bank card (with respect to available display space). The user may view the commercial service information when the user is interested in the commercial service information corresponding to this virtual bank card, so that the displaying interference to the virtual bank card from the commercial service information (e.g., overlap on the display screen) may be avoided and thus graphic user interface utilization may be improved.

According to embodiments of the present disclosure, the list of the commercial service information may be displayed by triggering the surface of the card, such that the user may view the commercial service information corresponding to a virtual bank card in another GUI intensively if the user is interested in the commercial service information corresponding to this virtual bank card. In this way, the commercial service information the user is interested in may be gathered in a same GUI. Thus, the GUI displaying more commercial service information may be provided to the user and display efficiency may be improved.

According to embodiments of the present disclosure, the list of the commercial service information may be displayed by triggering the commercial service information, such that the user may view the commercial service information corresponding to a virtual bank card in another GUI intensively after the user views the card information of this visual bank card (noting, for example, that a balance of this virtual bank card is sufficient) and if the user is interested in the commercial service information corresponding to this virtual bank card. In this way, the commercial service information the user is interested in may be gathered in a same GUI. Thus, the GUI displaying more commercial service information may be provided to the user and the displaying efficiency may be improved.

According to embodiments of the present disclosure, the GUI of the vendor may be displayed by triggering the commercial service information, such that the user may get access to the GUI of the vendor quickly to acquire the address, the contact information, and/or navigation information (from the user terminal's geographical location) of the vendor if the user is interested in the commercial service information of the vendor, such that the user is guided to use a service provided by the vendor on-line or off-line. Thus, a difficulty of the user acquiring the commercial service information may be reduced and an operating procedure of the user may be simplified under the usage scenario.

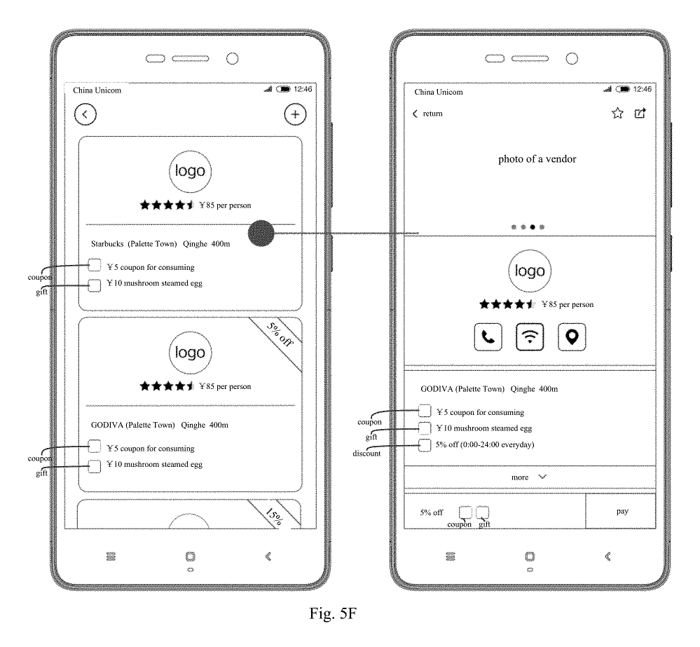

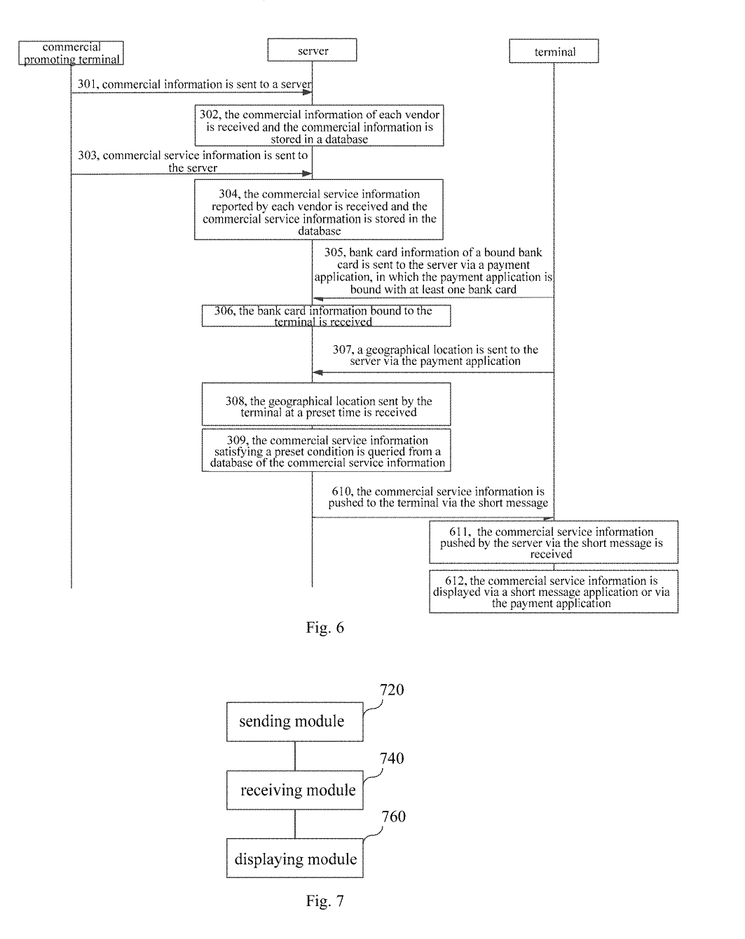

In one or more embodiments, a process for pushing information described above may be realized via a short message service. That is, acts 310-312 may be alternatively realized as acts 610-611, as shown in FIG. 6.

In act 610, the server pushes the commercial service information to the terminal via the short message.

In act 611, the terminal receives the commercial service information pushed by the server via the short message.

In act 612, the terminal displays the commercial service information via a short message application or via the payment application.

In one or more implementations, the terminal displays the commercial service information via a short message application.

In one or more implementations, when the payment application has a right to read the short message, the terminal may also display the commercial service information via the payment application.

Consequently, according to the example method for pushing information in embodiments of the present disclosure, by pushing the commercial service information via the short message, the terminal may acquire the commercial service information without data network, so that reliability of information pushing may be improved.

It should be additionally noted that in method embodiments described above, a method for acquiring the geographical location by the terminal includes but is not limited to: at least one of the iBeacon technology, GPS technology, WIFI locating technology, and base station locating technology.

The iBeacon technology is introduced as follows: a Bluetooth Low Energy (BLE) device is disposed in an off-line shop of a vendor, in which the BLE device may send a broadcast frame periodically, and the terminal supporting BLE may receive the broadcast frame and locate according to the broadcast frame. Alternatively, the broadcast frame includes a universally unique identifier (UUID) field, a Major field, a Minor field, and a Measured Power field. UUID is a 128-bits identifier conforming with ISO/IEC 11578:19126 Standard; the Major filed includes address information and advisory information inputted by the vendor; the Minor filed includes an identification of the off-line shop; the Measured Power filed includes a referenced received signal strength when a distance between the BLE device and a user device is one meter, such that the user device may estimate the distance between the BLE device and the user device according to the referenced received signal strength and a real received signal strength.

The GPS technology is a locating technology based on satellite positioning. Besides a GPS system of USA, common satellite positioning system also includes BeiDou Navigation Satellite System (BDS) of China, and Global Navigation Satellite System (GLONASS) of Russia. In embodiments of the present disclosure, the satellite positioning systems are collectively known as GPS technology. The terminal may compute a distance between the terminal and three or four satellites via the received signals sent by the three or four satellites, and then obtain a location (X, Y, Z) of the terminal according to a distance formula in a 3-D coordinate system.

The WiFi locating technology locates the terminal according to a wireless access point where the terminal resides. For example, when an installing location registered when the wireless access point is installed is “XX Building, XX Office”, then the location of the terminal, which is “XX Building, XX Office”, may be queried according to the identification of the wireless access point when the terminal resides in the wireless access point.

The base station locating technology is also known as Location Based Service (LBS). Time of Arrival (TOA) or Time Difference of Arrival (TDOA) of downlink pilot signals of different base stations may be acquired respectively by measuring the downlink pilot signals of different base stations by the terminal of the user. The location of the terminal may be computed by using a triangle formula estimating algorithm and combining the location of the base station with measuring results.

It should be noted that acts executed by the commercial promoting terminal in method embodiments of the present disclosure may be realized independently as the method for pushing information at the commercial promoting terminal side. Acts executed by the server may be realized independently as the method for pushing information at the server side. Acts executed by the terminal may be realized independently as a method for displaying and/or receiving information at the terminal side.

Device embodiments for implementing the method embodiments of the present disclosure are described as follows. For details which are not disclosed in the device embodiments, reference is made to the method embodiments of the present disclosure.

Regarding the device in these embodiments, the specific ways of implementing operations by each module have been illustrated in the method embodiments, which will not be further elaborated herein.

FIG. 7 is a block diagram illustrating a device for displaying information according to an example embodiment of the present disclosure. The device may be realized as all or a part of the terminal illustrated in FIG. 1 via a specialized hardware circuit or a combination of hardware and software. The device includes a sending module 720, a receiving module 740, and a displaying module 760.

The sending module 720 is configured to send bank card information of a bound bank card to a server. The sending module 720 is further configured to send a geographical location to the server.

The receiving module 740 is configured to receive commercial service information pushed by the server, in which the commercial service information matches the bank card information and the geographical location.

The displaying module 760 is configured to display the commercial service information.

In one or more alternative embodiments, the sending module 720 is configured to send the bank card information to the server via a payment application, and the payment application is bound with at least one bank card.

In one or more alternative embodiments, the sending module 720 is further configured to send the geographical location to the server when booting; or the sending module 720 is further configured to send the geographical location to the server at a starting time of a payment application; or the sending module 720 is further configured to send the geographical location to the server at a predetermined time interval.

In one or more alternative embodiments, the displaying module 760 is configured to display a GUI of a card, and the GUI of the card includes at least one virtual bank card, in which all or a part of a content of the commercial service information is displayed on a surface of the at least one virtual bank card.

The content of the commercial service information may include at least one of: a logo, a name, a rating, an address, contact information, discount information, coupon information, group-purchasing information and gift information of a vendor, and a distance between a current location and the vendor.

In one or more alternative embodiments, the commercial service information displayed on the surface is the commercial service information matching the bank card information corresponding to the at least one virtual bank card.

In one or more alternative embodiments, the displaying module 760 is further configured to display all of the content of the commercial service information when a first triggering signal is received on the part of the content.

In an alternative embodiment, an aggregation logo is displayed on the surface of the at least one virtual bank card, and the aggregation logo is configured to indicate that a number of items of the commercial service information corresponding to the at least one virtual bank card exceeds a preset number.

The displaying module 760 is further configured to jump to a list GUI corresponding to the at least one virtual bank card when a second triggering signal is received on the aggregation logo, in which the list GUI includes each of the items of the commercial service information corresponding to the at least one virtual bank card respectively.

In one or more alternative embodiments, the displaying module 760 is further configured to display card information corresponding to the at least one virtual bank card when a third triggering signal is received on the surface of the at least one virtual bank card, in which the card information includes at least the commercial service information; and to jump to a list GUI corresponding to the at least one virtual bank card when a fourth triggering signal is received on the commercial service information, in which the list GUI includes each of the items of the commercial service information corresponding to the at least one virtual bank card respectively.

In one or more alternative embodiments, the displaying module 760 is further configured to display a GUI of a vendor corresponding to the commercial service information when a fifth triggering signal is received on the commercial service information, in which the GUI of the vendor includes information of the vendor corresponding to the commercial service information.

In one or more alternative embodiments, the displaying module 760 is further configured to display a notification message after the commercial service information is received; and to display the GUI of the card when the notification message is triggered.

In one or more alternative embodiments, the receiving module 740 is configured to receive the commercial service information pushed by the server via a short message.

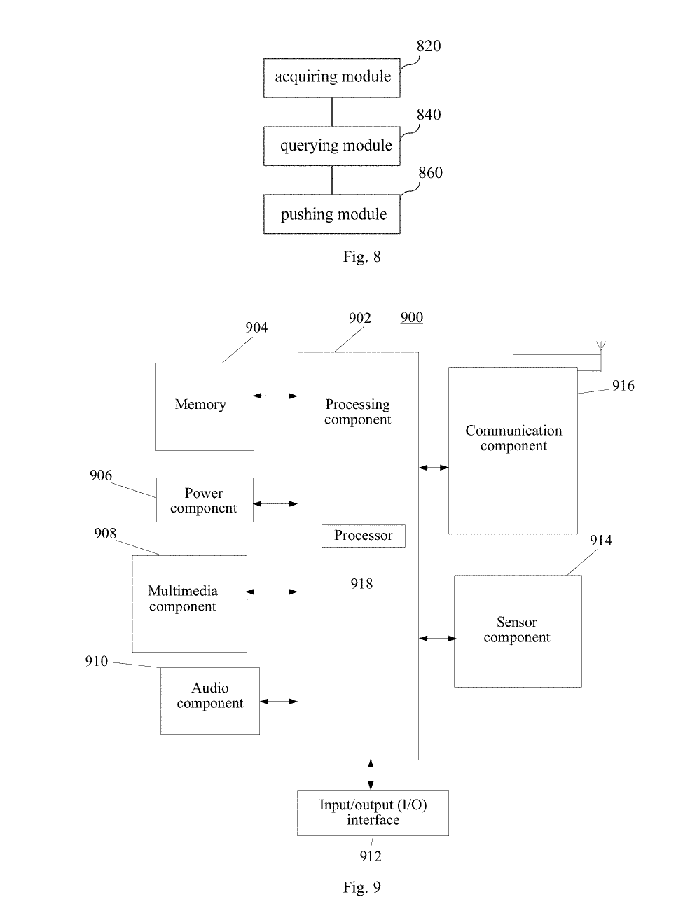

FIG. 8 is a block diagram illustrating a device for displaying information according to one or more example embodiments of the present disclosure. The device may be realized as all or a part of the server illustrated in FIG. 1 via a specialized hardware circuit or a combination of hardware and software. The device includes an acquiring module 820, a querying module 840, and a pushing module 860.

The acquiring module 820 is configured to acquire bank card information bound to a terminal. The acquiring module 820 is further configured to acquire a geographical location of the terminal. The querying module 840 is configured to query commercial service information matching the bank card information and the geographical location. The pushing module 860 is configured to push the commercial service information to the terminal.

In one or more alternative embodiments, the acquiring module 820 is configured to acquire the bank card information sent by a payment application in the terminal, in which the payment application is bound with at least one bank card.

In one or more alternative embodiments, the acquiring module 820 is configured to acquire the geographical location sent by the terminal at a preset time, in which the preset time includes at least one of:

a time when the terminal is booting;

a starting time of the payment application in the terminal; and

a time determined by a predetermined time interval.

In one or more alternative embodiments, the querying module 840 is configured to query the commercial service information satisfying a preset condition in a database of the commercial service information, in which the preset condition may include: a supported card type matching the bank card information, and, a preset distance between a location of a vendor and the geographical location being less than a preset threshold. The preset distance may be set according to hardware limits or other conditions during an initial setup by a terminal, a server, or other device.

In one or more alternative embodiments, the pushing module 860 is configured to push the commercial service information to the payment application in the terminal; or the pushing module 860 is configured to push the commercial service information via a short message.

The device in FIG. 8 may acquire bank card information linked with a bank card holder having a user terminal; acquire a geographical location of the user terminal from the user terminal; query commercial service information for applicability to the bank card holder, wherein the commercial service information includes a promotional offering available at a redemption point. The commercial service information is applicable to the bank card holder if: the geographical location of the user terminal is no farther than a preset distance from the redemption point; and the promotional offering is redeemable by the bank card holder. The device may further push the commercial service information to the user terminal to inform the bank card holder of the promotional offering available for redemption by the bank card holder at the nearby redemption point.

FIG. 9 is a block diagram illustrating a terminal according to an example embodiment of the present disclosure. For example, the terminal 900 may be a mobile phone, a computer, a digital broadcasting terminal, a message sending and receiving equipment, a game controller, a tablet device, a medical device, a fitness equipment, a personal digital assistant or the like.

Referring to FIG. 9, the terminal 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the terminal 900, such as the operations associated with display, telephone calls, data communications, camera operations, and recording operations. The processing component 902 may include one or more processors 918 to execute instructions to perform all or part of the steps in the above described example methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal 900. Examples of such data include instructions for any applications or methods operated on the terminal 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk, etc.

The power component 906 provides power to various components of the terminal 900. The power component 906 may include a power management system, one or more power sources, and any other components associated with the generation, management, and distribution of power in the terminal 900.

The multimedia component 908 includes a screen providing an output interface between the terminal 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the terminal 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the terminal 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the terminal 900. For instance, the sensor component 914 may detect an open/closed status of the terminal 900, relative positioning of components, e.g., the display and the keypad, of the terminal 900, a change in position of the terminal 900 or a component of the terminal 900, a presence or absence of user contact with the terminal 900, an orientation or an acceleration/deceleration of the terminal 900, and a change in temperature of the terminal 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal 900 and other devices. The terminal 900 can access a wireless network based on a communication standard, such as WiFi, 2G; or 3G; or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the terminal 900 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The device 900 may use the circuitries in combination with the other hardware or software components for performing the above described methods. Each module, sub-module, unit, or sub-unit disclosed above may be implemented at least partially using the one or more circuitries.

In example embodiments, there is also provided a non-transitory computer-readable storage medium including instructions, such as included in the memory 904, executable by the processor 918 in the terminal 900, for performing the above-described methods. For example, the non-transitory computer-readable storage medium may be a ROM, a RAM, a CD-ROM, a magnetic tape, a floppy disc, an optical data storage device, and the like.

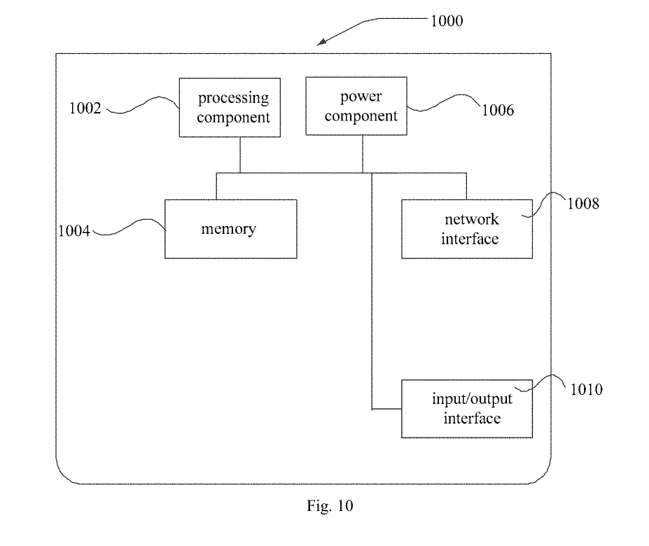

FIG. 10 is a block diagram illustrating a server according to one or more example embodiments of the present disclosure. For example, a server 1000 may be provided as a network-side device. Referring to FIG. 10, the server 1000 may include a processing component 1002 which further includes one or more processors, and a memory resource represented by a memory 1004, in which the memory resource is configured to store an instruction executed by the processing component 1002, such as an application. Applications stored in the memory 1004 may include one or more modules corresponding to a series of instructions. Furthermore, the processing component 1002 may be configured to execute the series of instructions so as to execute acts executed by the server in method embodiments of the present disclosure.

The server 1000 may further include a power component 1006 configured to execute power management of the server 1000, a wired or wireless network interface 1008 configured to connect the server 1000 to a network, and an input-output (I/O) interface 1010. The server may operate based on one or more operating systems such as Windows Server™, Mac OS XTM, Unix™, Linux™, FreeBSD™ or the like stored in the memory 1004.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for providing bank card holders specific information based on vicinity to a vendor, comprising:
transmitting, by a user terminal, bank card information of a bank card to a server, the bank card being linked with one or more accounts of the bank card holder;
determining a geographical location of the user terminal, and transmitting the geographical location from the user terminal to the server, wherein the geographical location of the user terminal is associated with where the bank card holder is located;
receiving commercial service information pushed by the server, wherein the commercial service information includes a promotional offering available at a redemption point, the promotional offering being provided by a vendor during a period of time, wherein the commercial service information is pushed to the user terminal when both:
the geographical location of the user terminal is no farther than a preset distance from the redemption point, and
the promotional offering is redeemable by the bank card holder; and
displaying the commercial service information at the user terminal to inform the bank card holder of the promotional offering available at the nearby redemption point.

2. The method according to claim 1, wherein transmitting bank card information of a bound bank card to a server comprises:
transmitting the bank card information to the server via a payment application, wherein the payment application is bound with at least one bank card.

3. The method according to claim 1, wherein transmitting the geographical location from the user terminal to the server comprises: sending the geographical location to the server at a preset time, wherein the preset time comprises at least one of:
a time when the terminal is booting;
a starting time of a payment application in the terminal; and
a time determined by a predetermined time interval.

4. The method according to claim 1, wherein displaying the commercial service information comprises:
displaying a graphical user interface (GUI) of a card, wherein the GUI of the card comprises at least one virtual bank card, wherein all or a part of a content of the commercial service information is displayed on a surface of the at least one virtual bank card.

5. The method according to claim 4, wherein the commercial service information displayed on the surface comprises the commercial service information corresponding to the at least one virtual bank card.

6. The method according to claim 4, wherein when the part of the content of the commercial service information is displayed on the surface, the method further comprises:
displaying all of the content of the commercial service information when a first triggering signal is received on the part of the content.

7. The method according to claim 4, wherein an aggregation logo is displayed on the surface of the at least one virtual bank card, in which the aggregation logo is configured to indicate that a number of items of the commercial service information corresponding to the at least one virtual bank card exceeds a preset number, and wherein the method further comprises:
jumping to a list GUI corresponding to the at least one virtual bank card when a second triggering signal is received on the aggregation logo, wherein the list GUI comprises each of the items of the commercial service information corresponding to the at least one virtual bank card respectively.

8. The method according to claim 4, further comprising:
displaying card information corresponding to the at least one virtual bank card when a third triggering signal is received on the surface of the at least one virtual bank card, wherein the card information comprises at least the commercial service information; and
jumping to a list GUI corresponding to the at least one virtual bank card when a fourth triggering signal is received on the commercial service information, wherein the list GUI comprises each of items of the commercial service information corresponding to the at least one virtual bank card respectively.

9. The method according to claim 4, further comprising:
displaying a GUI of a vendor corresponding to the commercial service information when a fifth triggering signal is received on the commercial service information, wherein the GUI of the vendor comprises information of the vender corresponding to the commercial service information.

10. The method according to claim 4, further comprising:
displaying a notification message after the commercial service information is received; and
displaying the GUI of the card when the notification message is triggered.

11. The method according to claim 4, wherein the content of the commercial service information comprises at least one of: a logo, a name, a rating, an address, contact information, discount information, coupon information, group-purchasing information and gift information of a vendor, and a distance between a current location and the vendor.

12. The method according to claim 1, wherein receiving commercial service information pushed by the server comprises:
receiving the commercial service information pushed by the server via a short message.

13. A method for pushing specific information to bank card holders based on vicinity to a vendor, comprising:
acquiring bank card information linked with a bank card holder having a user terminal;
acquiring a geographical location of the user terminal from the user terminal;
querying commercial service information for applicability to the bank card holder, wherein the commercial service information includes a promotional offering available at a redemption point, and wherein the commercial service information is applicable to the bank card holder if:
the geographical location of the user terminal is no farther than a preset distance from the redemption point; and
the promotional offering is redeemable by the bank card holder; and
pushing the commercial service information to the user terminal to inform the bank card holder of the promotional offering available for redemption by the bank card holder at the nearby redemption point.

14. The method according to claim 13, wherein acquiring bank card information linked with the bank card holder having the user terminal comprises:
acquiring the bank card information sent by a payment application in the user terminal, wherein the payment application is linked with at least one bank card of the bank card holder.

15. The method according to claim 13, wherein acquiring the geographical location of the terminal comprises:
acquiring the geographical location sent by the terminal at a preset time, wherein the preset time comprises at least one of:
a time when the terminal is booting;
a starting time of a payment application in the terminal; and
a time determined by a predetermined time interval.

16. The method according to claim 13, wherein:
the promotional offering is redeemable by the bank card holder when a preset condition is satisfied, wherein the preset condition comprises the bank card being a supported card type as indicated in the bank card information.

17. The method according to claim 13, wherein pushing the commercial service information to the user terminal comprises:
pushing the commercial service information to a payment application in the terminal.

18. The method according to claim 13, wherein pushing the commercial service information to the user terminal comprises:
pushing the commercial service information via a short message.

19. A device for displaying information, comprising:
a processor;
a memory configured to store an instruction executable by the processor;
wherein the processor is configured to:
transmit bank card information of a bank card to a server, the bank card being linked with one or more accounts of the bank card holder;
determine a geographical location of the device and transmit the geographical location to the server, wherein the geographical location is associated with where the bank card holder is located;
receive commercial service information pushed by the server, wherein the commercial service information includes a promotional offering available at a redemption point, the promotional offering being provided by a vendor during a period of time, wherein the commercial service information is pushed to the device when both:
the geographical location of the device is no farther than a preset distance from the redemption point, and
the promotional offering is redeemable by the bank card holder;
display the commercial service information to inform the bank card holder of the promotional offering available at the nearby redemption point.
